(19) United States
(12) Patent Application Publication
(10) Pub. No.: US 2017/0187800 A1
(43) Pub. Date: Jun. 29, 2017

(54) FILE SYNCHRONIZATION METHOD, ELECTRONIC DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yuexian ZHAO, Beijing (CN)

(21) Appl. No.: 15/244,145

(22) Filed: Aug. 23, 2016

Related U.S. Application Data
(63) Continuation of application No. PCT/CN2016/088701, filed on Jul. 5, 2016.

(30) Foreign Application Priority Data
Dec. 28, 2015 (CN) 2015110010485

(51) Int. Cl. H04L 29/08; H04L 29/06

(52) U.S. Cl. CPC H04L 67/1095; H04L 67/06; H04L 67/42

(57) ABSTRACT

Disclosed are a file synchronization method and an electronic device. The file synchronization method includes receiving a file synchronization message which is transmitted by a publishing device and contains a file path of the file to be synchronized, storing the said file path in a database; obtaining the said file path from the said database, obtaining file information of the said file, which is to be synchronized, based on the said file path; and transmitting in parallel the said file information to a distributed cluster of apparatus in order to synchronize the file, which is to be synchronized, onto the distributed cluster of apparatus.

### CROSS REFERENCE TO RELATED APPLICATIONS

The present application is a continuation of PCT application which has an application number of PCT/CN2016/088701 and was filed on Jul. 5, 2016. This application claims the priority to Chinese Patent Application No. 2015110010485, filed with the State Intellectual Property Office of People's Republic of China on Dec. 28, 2015, which is incorporated herein by reference in its entirety.

### TECHNICAL FIELD

The present disclosure relates to the field of communication technology, and particularly a file synchronization method and an electronic device.

### BACKGROUND

Internet content is becoming richer as a growing number of Internet users, a great number of content resources such as a picture, a static file are accumulated in each Internet application after many years. A single apparatus cannot store the files, therefore, a distributed cluster way is required, so as to adopt N apparatus to store the files. Internet content changes every second; and the latest content is more valuable and meaningful. Due to the rapid development of the existing Internet and a great number of users, the days when a single apparatus can meet the requirement are no longer existed; a website having a large traffic often requires a cluster consisting of multiple apparatus to provide a service. Once the content is changed, the changed content is quickly synchronized onto all cluster apparatus, so that the user can acquire the latest information in time. An indispensable part for improving the timeliness of the website and the user's experience is to synchronize and quickly update the content and in time by a server cluster.

Traditionally, a file is synchronized onto a cluster apparatus one by one by scanning a hard drive. In this case, the file is synchronized onto only one apparatus, and can not be synchronized onto multiple cluster apparatus simultaneously, therefore, it will take a long time to synchronize a great number of files, and it is unable to perform a synchronization operation onto multiple cluster apparatus since that synchronization in bulk is not supported, which results in a time difference of synchronization and content missing.

### SUMMARY

In view of the problems described above, a file synchronization method and an electronic device are provided according to the present disclosure, in order to overcome or at least solve the problems described above.

A file synchronization method is provided according to an aspect of an embodiment of the present disclosure, the file synchronization method includes:

receiving a file synchronization message, containing a file path of a file to be synchronized, transmitted by a publishing device, storing the file path in a database;

obtaining a file path from the database, obtaining the file information of the file to be synchronized based on the file path; and

transmitting the file information in parallel to a distributed cluster of apparatus, to synchronize the file to be synchronized onto the distributed cluster of apparatus.

An electronic device is provided according to another aspect of an embodiment of the present disclosure, comprising:

at least one processor; and a memory communicably connected with the said at least one processor; wherein the said memory stores instructions executable by the said at least one processor, the said instructions are executed by the said at least one processor, the said instructions are configured to execute a file synchronization method prescribed by the present application.

A non-transitory computer-readable storage medium, wherein the said non-transitory computer-readable storage medium can store computer-executable instructions is provided according to another aspect of an embodiment of the present disclosure, the said computer-executable instructions are configured to execute the said file synchronization method of the present application.

The description above is only an overview of the technical solution of the present disclosure. In order to understand the technical means of the present disclosure clearer, by embodying technical solution according to a content of the specification and making the above-described and other objectives, features and advantages of the present disclosure obvious and easy to be understood, specific embodiments of the present disclosure are described below.

### BRIEF DESCRIPTION OF THE DRAWINGS

One or more embodiments of the present invention are to be further elaborated in detail with reference to the accompanying figures. It should be noted that, unless specifically stated otherwise, components and procedures of corresponding arrangements, numerical expressions and values disclosed do not limit the scope of the present invention. The drawings are not to scale, unless being specified otherwise.

FIG. 1 is a flow chart of a file synchronization method according to an embodiment of the present disclosure;

FIG. 2 is a flow chart of a file synchronization method according to another embodiment of the present disclosure;

FIG. 3 is a structural block diagram of a file synchronization device according to an embodiment of the present disclosure;

FIG. 4 is a structural block diagram of a file synchronization device according to another embodiment of the present disclosure;

FIG. 5 is a structural block diagram of a file synchronization system according to an embodiment of the present disclosure; and

FIG. 6 illustrates a hardware structure of a device executing file synchronization method according to an embodiment of the present disclosure.

### DETAILED DESCRIPTION

The exemplary embodiments of the present disclosure are described in detail below in conjunction with the drawings. Although the exemplary embodiments of the present disclosure are shown in the drawings, it should be understood that the present disclosure can be realized in various ways and are not limited to be realized by the embodiments described herein. In contrast, the embodiments are provided to those skilled in the art for the purpose of thorough understanding of the present disclosure and conveying the scope of the present disclosure.

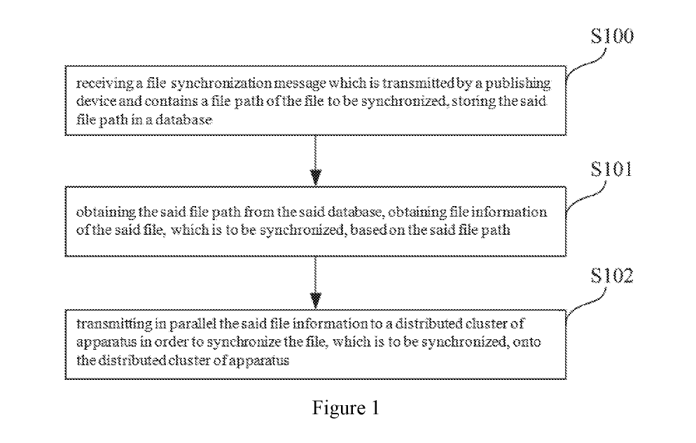

FIG. 1 is a flow chart of a file synchronization method according to an embodiment of the present disclosure. As shown in FIG. 1, the said file synchronization method includes the following steps.

Step S100 receives a file synchronization message which is transmitted by a publishing device and contains a file path of the file to be synchronized, and stores the said file path in a database.

Specifically, the file synchronization message indicates that a file on the publishing device has been updated, and it is required to synchronize the updated file onto a distributed cluster of apparatus, and the updated file here is the file to be synchronized. Specifically, file update includes adding file contents, modifying file contents, deleting file contents or others.

The database is of being efficient, reliable and secure, which guarantees safe storage of data. In the embodiment, file paths of all updated files can be stored in the database, thereby realizing synchronization in bulk. Also, the file path of the file to be synchronized is stored in the database, so that a part of the file to be synchronized can be avoided from not being synchronized onto the distributed cluster of apparatus. In addition, since the file paths are stored in the database, when a computer room powers up following a power down period or when a downed apparatus is restarted again, previous synchronization can be resumed, thereby saving synchronization duration and avoiding unnecessary repeated synchronization.

Step S101 obtains the file path from the database, and obtains file information of the file, which is to be synchronized, based on the file path.

Once the file path of the file to be synchronized is stored in the database in step S100, step S101 is executed, to obtain the file path from the database and the file information on the file to be synchronized based on the file path. Optionally, the file information includes file contents and file property.

In step S102, the file information is transmitted apparatus in parallel to a distributed cluster of apparatus to synchronize the file, which is to be synchronized, onto the distributed cluster of apparatus.

In the embodiment of the present disclosure, the file to be synchronized is synchronized in parallel, so that the file to be synchronized is synchronized to multiple cluster apparatus simultaneously, thereby avoiding a part of the file to be synchronized from being missed due to time difference of the synchronization. Also, a synchronization operation for apparatus has no affect on a synchronization operation for another apparatus since that the file to be synchronized is synchronized in parallel.

In the file synchronization method according to the embodiment of the present disclosure, since the database is of being efficient, reliable and secure, the file path is stored in the database. By this way, after a computer room which powers down or a downed apparatus is restarted, previous synchronization can be continued without synchronizing the file to be synchronized again, thereby saving synchronization duration and avoiding unnecessary repeated synchronization. File paths of all updated files can be stored in the database, thereby realizing synchronization in bulk. Also, the file path of the file to be synchronized is stored in the database, so that a part of the file to be synchronized can be avoided from not being synchronized onto the distributed cluster of apparatus. The file to be synchronized is synchronized in parallel, so that the file to be synchronized are synchronized onto multiple cluster apparatus simultaneously, thereby avoiding a part of the file to be synchronized from being missed due to time difference of synchronization. Also, a synchronization operation for apparatus has no affect on a synchronization operation for another apparatus since that the file to be synchronized is synchronized in parallel, thereby saving the time of synchronization.

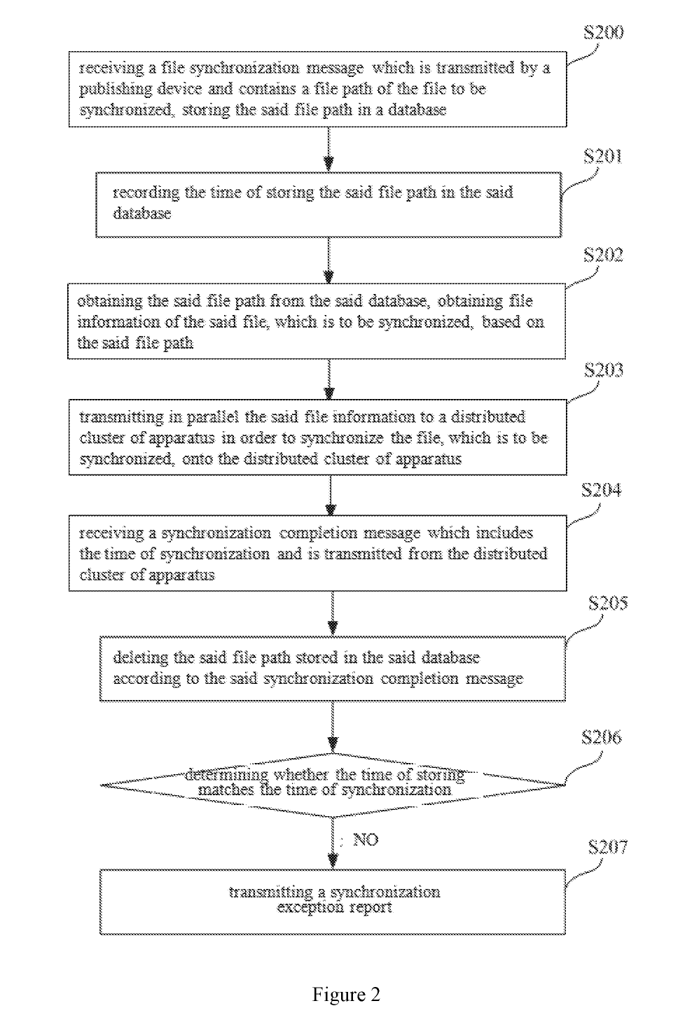

FIG. 2 is a flow chart of a file synchronization method according to another embodiment of the present disclosure. As shown in FIG. 2, the file synchronization method includes the following steps.

In step S200, a file synchronization message containing a file path of a file to be synchronized transmitted by a publishing device is received, and the file path is stored in a database.

Specifically, the file synchronization message indicates that a file on the publishing device is updated, and it is required to synchronize the updated file onto a distributed cluster of apparatus.

In the embodiment of the present disclosure, updating the file includes adding file contents, modifying file contents, deleting file contents or others. Since the user updates the file on the publishing device, the publishing device can obtain the file path of the file after the file is updated. The publishing device encapsulates the file path in a file synchronization message, and then transmits the file synchronization message containing the file path of the file to be synchronized. The file to be synchronized refers to the updated file to be synchronized onto a distributed cluster of apparatus.

Since the database is of being efficient, reliable and secure, it guarantees safe storage of data. In the embodiment of the present disclosure, file paths of all updated files can be stored in the database, thereby realizing synchronization in bulk. Also, the file path of the file to be synchronized is stored in the database, so that a part of the updated file can be avoided from not being synchronized onto the distributed cluster of apparatus. In addition, since the file path is stored in the database, after a computer room which powers down or a downed apparatus is restarted, previous synchronization can be continued without synchronizing the file to be synchronized again, thereby saving synchronization duration and avoiding unnecessary repeated synchronization.

In step S201, the time of storing the said file path is recorded in the database.

After the file path is stored in the database, the time of storing of the file path is recorded in the database; the time of storing of the file path may be used in a subsequent step of the file synchronization method to determine whether the file to be synchronized is synchronized onto the distributed cluster of apparatus in time.

In step S202, the file path is obtained from the database, and file information of the file to be synchronized is obtained according to the file path.

In the embodiment of the present disclosure, the file information includes file contents and file property. Specifically, the file property includes size of the file, modification time of the file, type of the file, permission of the file and a file password. The permission of the file concerns opening (or reading) and writing on the file. Specifically, the file contents and the file property of the file to be synchronized are obtained based on the file path.

In the embodiment of the present disclosure, not only the file contents are synchronized onto the distributed cluster of apparatus, but also the file property is synchronized onto the distributed cluster of apparatus, to reproduce the file to be synchronized on the distributed cluster of apparatus, so that the file on the distributed cluster of apparatus is identical with the file on the publishing device, thereby ensuring that the file presented to the user on the distributed cluster of apparatus is identical with the file on the publishing device.

In step S203, the file information is transmitted in parallel to the distributed cluster of apparatus to synchronize the file to be synchronized onto the distributed cluster of apparatus.

In the embodiment of the present disclosure, the file information can be transmitted in parallel to the distributed cluster of apparatus by TCP (Transmission Control Protocol) connection, for example, permanent TCP connection.

Permanent TCP connection means that a connection with the distributed cluster of apparatus is established, which is not disconnected since establishment, the file information is transmitted via the connection. Specifically, a connection request is sent to the distributed cluster of apparatus, permanent TCP connection is established upon receiving a connection response massage transmitted from the distributed cluster of apparatus; the file contents and the file property are then transmitted to the distributed cluster of apparatus in parallel, wherein the received file contents and the received file property are stored in the distributed cluster of apparatus, and it synchronizes the file which has to be synchronized.

In the embodiment of the present disclosure, since that the file to be synchronized is synchronized in parallel, the file to be synchronized is synchronized onto multiple cluster apparatus simultaneously, thereby avoiding a part of the file to be synchronized from being missed due to time difference of the synchronization. Also, a synchronization operation for apparatus has no affect on a synchronization operation for another apparatus since that the file to be synchronized is synchronized in parallel.

In step S204, a synchronization completion message which includes the time of synchronization is received from the distributed cluster of apparatus.

The distributed cluster of apparatus transmits a synchronization completion message which includes the time of synchronization after the file to be synchronized is synchronized. It can be known from the synchronization completion message that the synchronization is complete. The time of synchronization can be used to determine in a subsequent step of the file synchronization method whether the file to be synchronized is synchronized onto the distributed cluster of apparatus in time and whether there is a time delay.

In step S205, the file path stored in the database is deleted in response to the synchronization completion message.

After receiving the synchronization completion message, it can be determined that the synchronization operation on the file to be synchronized is complete. The file path stored in the database is deleted after it has been determined that the synchronization is complete, thereby avoiding the file to be synchronized from being missed and repeatedly performing the synchronization operation on the same file to be synchronized, and therefore saving space of the database.

In step S206, it is determined whether the time of storing matches the time of synchronization. Step S207 is executed where the time of storing does not match the time of synchronization, or the file synchronization method is ended where the time of storing matches the time of synchronization.

In the step S206, it is determined whether the time of storing matches the time of synchronization, for the purpose of determining whether the file to be synchronized is synchronized onto the distributed cluster of apparatus in time. Where the time of storing does not match the time of synchronization, an exception may occur in the synchronization process, for example, network jitter or network outages.

In step S207, a synchronization exception report is transmitted.

A synchronization exception report is transmitted where it is detected that the time of storing does not match the time of synchronization, the operation and maintenance personnel then perform trouble-shooting in response to the synchronization exception report, thereby ensuring that a subsequent synchronization operation can be performed in time.

In the file synchronization method according to the embodiment of the present disclosure, since the database has characteristics such as high efficiency, stability and security, the file path is stored in the database. In this way, after a computer room which powers down or a downed apparatus is restarted, previous synchronization can be continued without synchronizing the file to be synchronized again, thereby saving synchronization duration and avoiding unnecessary repeated synchronization. File paths of all the updated files can be stored in the database, thereby realizing synchronization in bulk. Also, the file path of the file to be synchronized is stored in the database, so that a part of the file to be synchronized can be avoided from not being synchronized onto the distributed cluster of apparatus. The file to be synchronized is synchronized in parallel, so that the file to be synchronized are synchronized onto multiple cluster apparatus simultaneously, thereby avoiding a part of the file to be synchronized from being missed due to time difference of synchronization. Also, a synchronization operation for apparatus has no affect on a synchronization operation for another apparatus since that the file to be synchronized is synchronized in parallel. Upon receiving the synchronization completion message, the file path stored in the database is deleted in response to the synchronization completion message, thereby avoiding the file to be synchronized from being missed and avoiding repeatedly performing the synchronization operation on the same file to be synchronized, and therefore saving space of the database. It can be determined whether the file to be synchronized is synchronized in time by detecting whether the time of storing matches the time of synchronization, an exception may occur in the synchronization process where the time of storing does not match the time of synchronization, and the synchronization exception report is transmitted, then the operation and maintenance personnel perform trouble-shooting in response to the synchronization exception report, thereby ensuring that a subsequent synchronization operation can be performed in time.

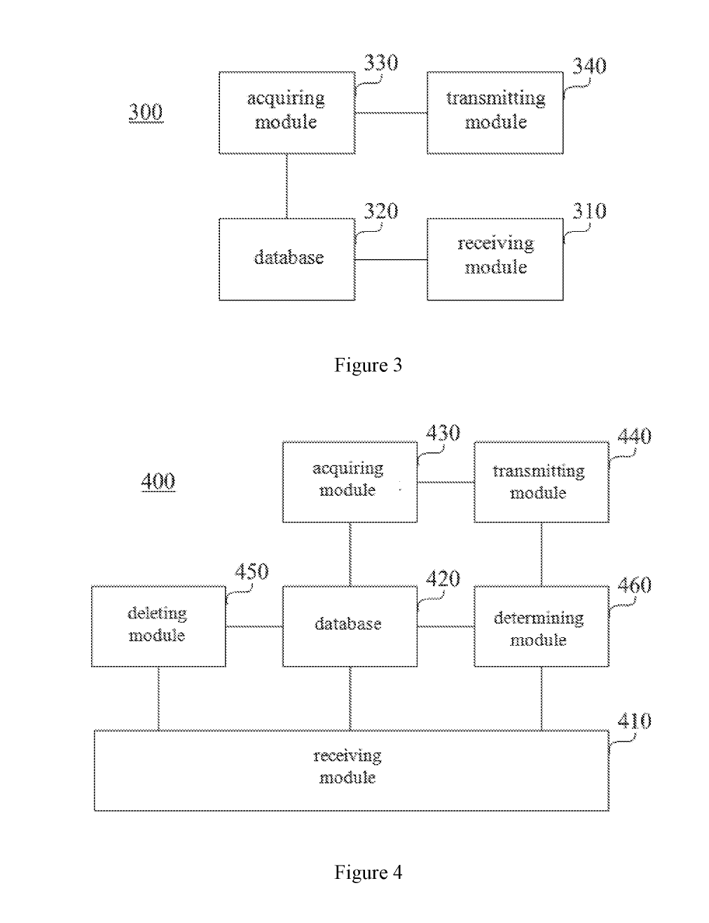

FIG. 3 is a structural block diagram of a file synchronization device according to an embodiment of the present disclosure. As shown in FIG. 3, the file synchronization device includes a receiving module 310, a database 320, an acquiring module 330 and a transmitting module 340.

The receiving module 310 is configured to receive a file synchronization message containing a file path of the file to be synchronized transmitted by a publishing device.

The database 320 is configured to store the file path.

The acquiring module 330 is configured to obtain the file path from the database, and obtain file information of the file to be synchronized according to the file path.

The transmitting module 340 is configured to send in parallel the file information to a distributed cluster of apparatus to synchronize the file to be synchronized onto the distributed cluster of apparatus.

In the file synchronization device according to the embodiment of the present disclosure described above, since the database has characteristics such as high efficiency, stability and security, the file path is stored in the database. In this way, after a computer room which powers down or a downed apparatus is restarted, previous synchronization can be continued without synchronizing the file to be synchronized again, thereby saving synchronization duration and avoiding unnecessary repeated synchronization. File paths of all the updated files can be stored in the database, thereby realizing synchronization in bulk. Also, the file path of the file to be synchronized is stored in the database, so that a part of the file to be synchronized can be avoided from not being synchronized onto the distributed cluster of apparatus. The file to be synchronized is synchronized in parallel, so that the file to be synchronized are synchronized onto multiple cluster apparatus simultaneously, thereby avoiding a part of the file to be synchronized from being missed due to time difference of synchronization. Also, a synchronization operation for apparatus has no affect on a synchronization operation for another apparatus since that the file to be synchronized is synchronized in parallel, thereby saving the time of synchronization.

FIG. 4 is a structural block diagram of a file synchronization device according to another embodiment of the present disclosure. As shown in FIG. 4, the file synchronization device 400 includes: a receiving module 410, a database 420, an acquiring module 430 and a transmitting module 440.

The receiving module 410 is configured to receive a file synchronization message containing a file path of the file to be synchronized which is transmitted by a publishing device.

Specifically, the file synchronization message indicates that a file on the publishing device is updated, and it is required to synchronize the updated file onto a distributed cluster of apparatus.

The database 420 is configured to store the file path.

Since the database has characteristics such as high efficiency, stability and security, the database provides a guarantee for data storage. In the embodiment, file paths of all the updated files can be stored in the database, thereby realizing synchronization in bulk. Also, the file path of the file to be synchronized is stored in the database, so that a part of the file to be synchronized can be avoided from not being synchronized onto the distributed cluster of apparatus. In addition, since the file path is stored in the database, after a computer room which powers down or a downed apparatus is restarted, previous synchronization can be continued without synchronizing the file to be synchronized again, thereby saving synchronization duration and avoiding unnecessary repeated synchronization.

The acquiring module 430 is configured to obtain the file path from the database, and obtain file information of the file to be synchronized based on the file path.

Optionally, the file information includes file contents and file property. Specifically, the file property includes size of the file, modification time of the file, type of the file, permission of the file and a file password.

The transmitting module 440 is configured to send the file information to a distributed cluster of apparatus, to synchronize the file, which is to be synchronized, onto the distributed cluster of apparatus.

In the embodiment of the present disclosure, the file information can in parallel be transmitted to the distributed cluster of apparatus by TCP connection, for example, permanent TCP connection.

In the embodiment of the present disclosure, since that the file to be synchronized is synchronized in parallel, the file to be synchronized is synchronized onto multiple cluster apparatus simultaneously, thereby avoiding a part of the file to be synchronized from being missed due to time difference of the synchronization. Also, a synchronization operation for apparatus has no affect on a synchronization operation for another apparatus since that the file to be synchronized is synchronized in parallel.

Optionally, the receiving module 410 is further configured to receive a synchronization completion message which includes the time of synchronization transmitted from the distributed cluster of apparatus.

The device further includes: a deleting module 450, which is configured to delete the file path of the file to be synchronized stored in the database in response to the synchronization completion message.

Optionally, time of storing the said file path is further recorded in the database 420.

The device further includes: a determining module 460, which is configured to determine whether the time of storing matches the time of synchronization.

The transmitting module 440 is further configured to transmit a synchronization exception report where it is determined by the determining module that the time of storing does not match the time of synchronization.

In the file synchronization device according to the embodiment of the present disclosure, since the database has characteristics such as high efficiency, stability and security, the file path is stored in the database. In this way, after a computer room which powers down or a downed apparatus is restarted, previous synchronization can be continued without synchronizing the file to be synchronized again, thereby saving synchronization duration and avoiding unnecessary repeated synchronization. File paths of all the updated files can be stored in the database, thereby realizing synchronization in bulk. Also, the file path of the file to be synchronized is stored in the database, so that a part of the file to be synchronized can be avoided from not being synchronized onto the distributed cluster of apparatus. The file to be synchronized is synchronized in parallel, so that the file to be synchronized are synchronized onto multiple cluster apparatus simultaneously, thereby avoiding a part of the file to be synchronized from being missed due to time difference of synchronization. Also, a synchronization operation for apparatus has no affect on a synchronization operation for another apparatus since that the file to be synchronized is synchronized in parallel. Upon receiving the synchronization completion message, the file path stored in the database is deleted in response to the synchronization completion message, thereby avoiding the file to be synchronized from being missed and avoiding repeatedly performing the synchronization operation on the same file to be synchronized, and therefore saving space of the database. It can be determined whether the file to be synchronized is synchronized in time by detecting whether the time of storing matches the time of synchronization, an exception may occur in the synchronization process where the time of storing does not match the time of synchronization, and the synchronization exception report is transmitted, then the operation and maintenance personnel perform trouble-shooting in response to the synchronization exception report, thereby ensuring that a subsequent synchronization operation can be performed in time.

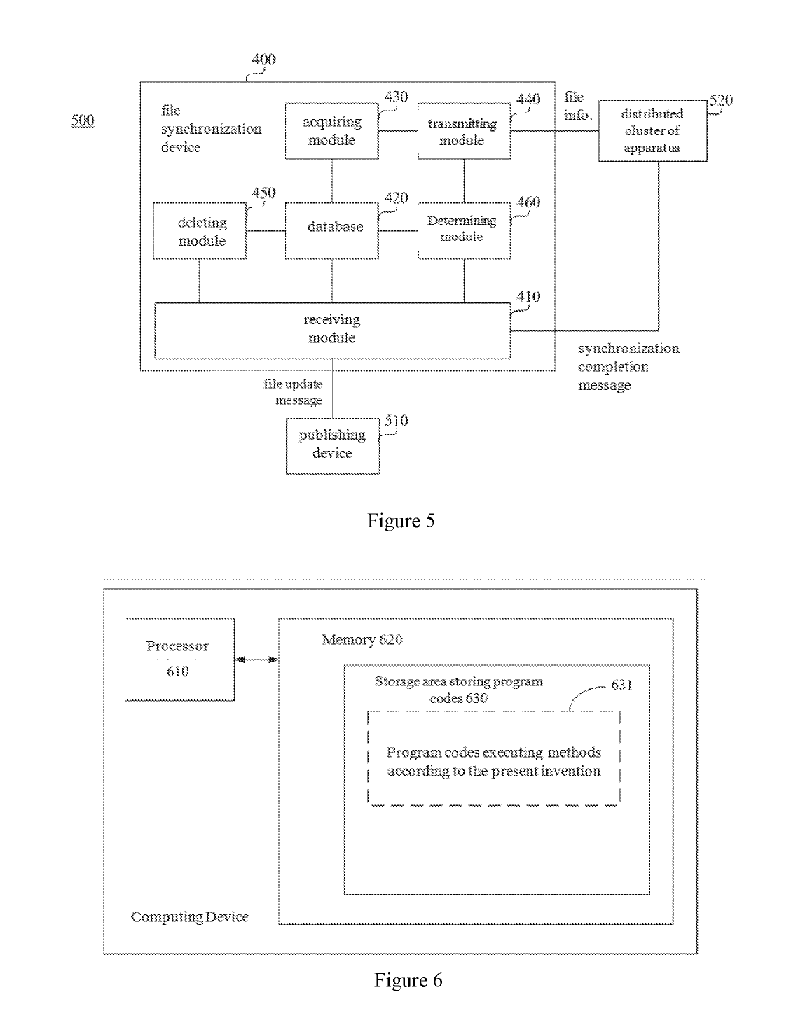

FIG. 5 is a structural block diagram of a file synchronization system according to an embodiment of the present disclosure. As shown in FIG. 5, the system 500 includes: a file synchronization device 400, a publishing device 510 and a distributed cluster of apparatus 520.

In the file synchronization system according to the embodiment of the present disclosure described above, the file to be synchronized is synchronized in parallel, so that the file to be synchronized is synchronized to multiple cluster apparatus simultaneously, thereby avoiding a part of the file to be synchronized from being missed due to time difference of the synchronization. A synchronization operation for apparatus has no affect on a synchronization operation for another apparatus since that the file to be synchronized is synchronized in parallel, thereby having a good synchronization performance and a fast synchronization speed.

A non-transitory computer-readable storage medium, wherein the said non-transitory computer-readable storage medium can store computer-executable instructions, is provided according to an embodiment of the present disclosure, and the said computer-executable instructions are configured to execute any one of the said file synchronization methods of the present application.

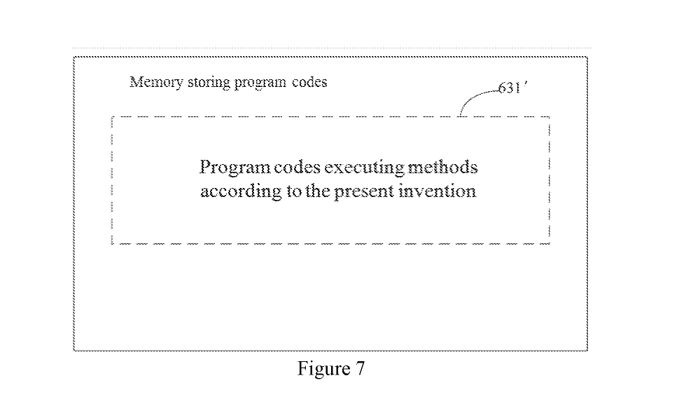

FIG. 6 illustrates the hardware structure of the electronic device executing a file synchronization method. As shown in FIG. 6, such device comprises:

one or several processors 610, and a memory 620 which is shown in FIG. 6 as an example.

the device executing the file synchronization method further comprises: an input device 630 and an output device 640.

processor 610, memory 620, input device 630 and output device 640 can be connected by BUS or other methods, and BUS connecting is showed in FIG. 6 as an example.

Memory 620 can be used for storing non-transitory software program, non-transitory computer executable program and modules as a non-transitory computer-readable storage medium, such as corresponding program instructions/modules for the methods for file synchronization according to embodiments of the present disclosure (such as shown in FIG. 3, receiving module 310, database 320, acquiring module 330 and transmitting module 340). Processor 610 by executing non-transitory software program performs all kinds of functions of a server and process data, instructions and modules which are stored in memory 620, thereby realizes the methods of file synchronization according to the above-mentioned embodiments of the present disclosure.

Memory 620 can include program storage area and data storage area, thereby the operating system and applications required by at least one function can be stored in program storage area and data created by using the device for file synchronization can be stored in data storage area. Furthermore, memory 620 can include high speed Random-access memory (RAM) or non-volatile memory such as hard disk storage device, flash memory device or other non-volatile solid state storage devices. In some embodiments, memory 620 can include long-distance setup memories relative to processor 610, which can communicate with the device for file synchronization by networks. The examples of said networks are including but not limited to Internet, Intranet, LAN, mobile Internet and their combinations.

Input device 630 can be used to receive inputted number, character information and key signals causing user configures and function controls of the device. Output device 640 can include a display screen or a display device.

The said module or modules are stored in memory 620 and perform any one of the file synchronization methods when executed by one or more processors 610.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a hard disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-9. (canceled)

10. A file synchronization method, comprising:
at an electronic device:
receiving a file synchronization message which is transmitted by a publishing device and contains a file path of the file to be synchronized, storing the said file path in a database;
obtaining the said file path from the said database, obtaining file information of the said file, which is to be synchronized, based on the said file path; and
transmitting in parallel the said file information to a distributed cluster of apparatus in order to synchronize the file, which is to be synchronized, onto the distributed cluster of apparatus.

11. The file synchronization method according to claim 10, further comprising:
receiving a synchronization completion message which includes the time of synchronization and is transmitted from the distributed cluster of apparatus; and
deleting the said file path stored in the said database according to the said synchronization completion message.

12. The file synchronization method according to claim 10, further comprising:
recording the time of storing the said file path in the said database; and
determining whether the said time of storing matches the said time of synchronization, and, if the time of storing does not match the time of synchronization, transmitting a synchronization exception report.

13. The file synchronization method according to claim 11, further comprising:
recording the time of storing the said file path in the said database; and
determining whether the said time of storing matches the said time of synchronization, and, if the time of storing does not match the time of synchronization, transmitting a synchronization exception report.

14. The file synchronization method according to claim 10, wherein the said file information comprises file contents and file property;
wherein the said file property includes size of the file, modification time of the file, type of the file, permission of the file and a file password.

15. An electronic device, comprising:
at least one processor; and
a memory communicably connected with the said at least one processor; wherein,
the said memory stores instructions executable by the said at least one processor, wherein
execution of the instructions by the said at least one processor causes the at least one processor to:
receive a file synchronization message which is transmitted by a publishing device and contains a file path of the file to be synchronized, store the said file path in a database;
obtain the said file path from the said database, and obtain file information of the said file, which is to be synchronized, based on the said file path; and
transmit in parallel the said file information to a distributed cluster of apparatus in order to synchronize the file, which is to be synchronized, onto the distributed cluster of apparatus.

16. The electronic device according to claim 15, wherein the said at least one processor further executes:
receiving a synchronization completion message which includes the time of synchronization and is transmitted from the distributed cluster of apparatus; and
deleting the said file path stored in the said database according to the said synchronization completion message.

17. The electronic device according to claim 15, wherein the said at least one processor further executes:
recording the time of storing the said file path in the said database; and
determining whether the said time of storing matches the said time of synchronization, and, if the time of storing does not match the time of synchronization, transmitting a synchronization exception report.

18. The electronic device according to claim 16, wherein the said at least one processor further executes:
recording the time of storing the said file path in the said database; and
determining whether the said time of storing matches the said time of synchronization, and, if the time of storing does not match the time of synchronization, transmitting a synchronization exception report.

19. The electronic device according to claim 15, wherein the said file information comprises file contents and file property;
wherein the said file property includes size of the file, modification time of the file, type of the file, permission of the file and a file password.

20. A non-transitory computer-readable storage medium, wherein the said non-transitory computer-readable storage medium can store computer-executable instructions, the said computer-executable instructions are configured to:
receive a file synchronization message which is transmitted by a publishing device and contains a file path of the file to be synchronized, store the said file path in a database;
obtain the said file path from the said database, and obtain file information of the said file, which is to be synchronized, based on the said file path; and
transmit in parallel the said file information to a distributed cluster of apparatus in order to synchronize the file, which is to be synchronized, onto the distributed cluster of apparatus.

21. The non-transitory computer-readable storage medium according to claim 20, wherein the said computer-executable instructions are further configured to:
receive a synchronization completion message which includes the time of synchronization and is transmitted from the distributed cluster of apparatus; and
delete the said file path stored in the said database according to the said synchronization completion message.

22. The non-transitory computer-readable storage medium according to claim 20, wherein the said computer-executable instructions are further configured to:
record the time of storing the said file path in the said database; and
determine whether the said time of storing matches the said time of synchronization, and, if the time of storing does not match the time of synchronization, transmit a synchronization exception report.

23. The non-transitory computer-readable storage medium according to claim 21, wherein the said computer-executable instructions are further configured to:
record the time of storing the said file path in the said database; and
determine whether the said time of storing matches the said time of synchronization, and, if the time of storing does not match the time of synchronization, transmit a synchronization exception report.

24. The non-transitory computer-readable storage medium according to claim 20, wherein the said file information comprises file contents and file property;
wherein the said file property includes size of the file, modification time of the file, type of the file, permission of the file and a file password.
